(19) United States
(12) Patent Application Publication
(10) Pub. No.: US 2026/0281764 A1
(43) Pub. Date: Sep. 17, 2026

(54) WIRELESS COMMUNICATION SYSTEM, WIRELESS COMMUNICATION METHOD, AND NON-TRANSITORY COMPUTER READABLE STORAGE MEDIUM

(71) Applicant: DENSO CORPORATION, Kariya-city (JP)

(72) Inventors: Sho MATSUMOTO, Kariya-city (JP); Youichi HAYASE, Kariya-city (JP); Yuto HONDA, Kariya-city (JP); Tadashi NAKASHIMA, Kariya-city (JP)

(73) Assignee: DENSO CORPORATION, Kariya-city (JP)

(21) Appl. No.: 19/561,673

(22) Filed: Mar. 10, 2026

Related U.S. Application Data
(63) Continuation of application No. PCT/JP2024/029882, filed on Aug. 22, 2024.

(30) Foreign Application Priority Data
Sep. 13, 2023 (JP) 2023-148805

(51) Int. Cl. H04W 24/08

(52) U.S. Cl. CPC H04W 24/08

(57) ABSTRACT

A wireless communication system includes a master device and a slave device. A communication quality of each communication channel is determined when the master device communicates wirelessly with the slave device, and one communication channel to be used for the wireless communication is determined based on a determination result of the communication quality of each communication channel. The master device is caused to transmit a channel map indicating a determined one communication channel to the slave device, and the master device and the slave device are caused to share the channel map. The channel map shared between the master device and the slave device is periodically updated. The update cycle of the channel map is changed in accordance with the communication state of the wireless communication between the master device and the slave device or an external instruction.

### CROSS REFERENCE TO RELATED APPLICATION

The present application is a continuation application of International Patent Application No. PCT/JP2024/029882 filed on Aug. 22, 2024, which designated the U.S. and claims the benefit of priority from Japanese Patent Application No. 2023-148805 filed on Sep. 13, 2023. The entire disclosures of all of the above applications are incorporated herein by reference.

### TECHNICAL FIELD

The present disclosure relates to a wireless communication system, a wireless communication method, and non-transitory computer readable storage medium for which at least one master device performs wireless communication with at least one slave device via one communication channel that is sequentially selected from a plurality of communication channels.

### BACKGROUND

A type of wireless communication system is known, for example, according to a conceivable technique. In the wireless communication system of the conceivable technique, when a packet error occurs in a reception signal of a wireless communication device, and the RSSI value of the wireless signal of the packet is larger than a predetermined threshold Th1, the wireless communication device determines that the reception operation for receiving the packet is a reception error due to interference with other electric waves. Then, the wireless communication device counts the number of receptions and the number of reception errors, and stores the frequency of reception errors due to the interference in each frequency channel (i.e., a value obtained by dividing the number of reception errors by the number of receptions). If the frequency of reception errors exceeds the threshold Th2, the wireless communication device determines that an interference source exists in the frequency channel for which the frequency of reception errors due to the interference exceeds the threshold Th2, and stores the frequency channel as an unusable channel.

### SUMMARY

According to an example, in a wireless communication system, at least one master device executes wireless communication with at least one slave device via one communication channel sequentially selected from a plurality of communication channels. The wireless communication system includes: at least one of (i) a circuit and (ii) a processor with a memory storing computer program code executable by the processor. The at least one of the circuit and the processor may be configured to cause the wireless communication system to execute: determining a communication quality of each of the plurality of communication channels when the at least one master device communicates wirelessly with the at least one slave device, and determining the one communication channel to be used for the wireless communication based on a determination result of the communication quality of each of the plurality of communication channels; causing the master device to transmit a channel map indicating the one communication channel in the determining of the one communication channel to the at least one slave device, and sharing the channel map between the master device and the at least one slave device, the channel map shared between the at least one master device and the at least one slave device in the sharing of the channel map being periodically updated; and changing an update cycle of the channel map shared between the at least one master device and the at least one slave device in the sharing of the channel map in accordance with a communication state of the wireless communication between the at least one master device and the at least one slave device or an external instruction.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a block diagram showing an overall configuration including a schematic configuration of a wireless communication system according to a first embodiment;

FIG. 2 is a diagram showing one example of the electric field strength distribution of the communication environment between the master device and the slave device;

FIG. 3 is a diagram showing an example of received signal strength of each communication channel;

FIG. 4 is a flowchart showing an example of an activation sequence between a master device and a slave device;

FIG. 5 is a flowchart showing an example of a communication sequence between a master device and a slave device;

FIG. 6 is a flowchart illustrating an example of the channel map update cycle setting process in the flowchart of FIG. 5;

FIG. 7 is a flowchart illustrating an example of the channel map sharing process in the flowchart of FIG. 5;

FIG. 8 is a time chart showing an example of the operation of a channel map sharing process when the update cycle of the channel map is set to X cycles;

FIG. 9 is a time chart showing an example of the operation of a channel map sharing process when the update cycle of the channel map is switched from X cycles to Y cycles;

FIG. 10 is a flowchart showing an example of the channel map update cycle setting process executed in the wireless communication system according to the second embodiment;

FIG. 11 is a flowchart showing an example of the channel map update cycle setting process executed in the master device of the wireless communication system according to the third embodiment;

FIG. 12 is a flowchart showing an example of process executed in the upper-level control device to give an external instruction to the master device to change the update cycle of the channel map;

FIG. 13 is a flowchart showing an example of process executed in the higher-level control device to give an external instruction to the master device to change the update cycle of the channel map according to a fourth embodiment;

FIG. 14 is a flowchart showing an example of process executed in the upper-level control device to give an external instruction to the master device to change the update cycle of the channel map according to a fifth embodiment; and

FIG. 15 is a time chart for explaining a modification example.

### DETAILED DESCRIPTION

As described above, in the wireless communication system according to the conceivable technique, a frequency channel whose communication quality has reduced due to interference with other electric waves is set as an unusable channel. Further, in the wireless communication system according to the conceivable technique, a frequency channel that is set as an unusable channel is restored to a usable frequency channel after a predetermined period has elapsed. Such control of setting a frequency channel as an unavailable channel or restoring the unavailable channel to an available channel is hereinafter referred to as channel map control in the embodiments.

Here, the frequency channels available for the wireless communication and the frequency channels to be restored from unavailable channels may change over time. For this reason, the channel map indicating available and/or unavailable channels needs to be updated periodically by, for example, a channel map control, and the updated channel map needs to be shared between devices performing the wireless communication. Sharing of the channel map can be performed, for example, by one device transmitting the next channel map to another device during the period after a channel map is updated and before updating to the next channel map.

However, if the channel map update cycle is constant, various difficulties may arise, as described below. For example, even if the communication environment is relatively good, it is possible that the number of times the next channel map is transmitted may be not sufficient during the period between updating the channel map and updating to the next channel map, so that the sharing of the next channel map is failed. In this case, if the channel map update cycle is long and the number of times the next channel map is transmitted is increased, the possibility of successfully sharing the next channel map can be increased. On the other hand, if a good communication environment deteriorates, due to the influence of noise, and the like, it cannot be said that the possibility of successfully sharing the next channel map can be increased even if the number of times the next channel map is transmitted is large. Furthermore, if an anomaly occurs in a control device that uses information transmitted or received by wireless communication between wireless communication devices, and if the channel map is not adapted to the communication environment at the time, in addition to the anomaly that has occurred, there is a high possibility that a communication anomaly will occur, so that the anomaly that has already occurred may be exacerbated.

The present embodiments have been made in consideration of the above-described points, and aims to provide a wireless communication system, a wireless communication method, and a wireless communication program that can solve the various difficulties described above by changing the update cycle of the channel map.

In order to achieve the above object, in a wireless communication system according to the present embodiments, at least one master device executes wireless communication with at least one slave device via one communication channel sequentially selected from a plurality of communication channels.

The wireless communication system includes: a communication channel determination unit that determines a communication quality of each communication channel when the at least one master device communicates wirelessly with the at least one slave device, and determines the one communication channel to be used for the wireless communication based on a determination result of the communication quality of each communication channel; a channel map share unit that causes the at least one master device to transmit a channel map indicating the one communication channel determined by the communication channel determination unit to the at least one slave device, and causes the at least one master device and the at least one slave device to share the channel map, the channel map shared between the at least one master device and the at least one slave device by the channel map share unit is periodically updated; and a cycle change unit that changes an update cycle of the channel map shared between the at least one master device and the at least one slave device by the channel map share unit in accordance with a communication state of the wireless communication between the at least one master device and the at least one slave device or an external instruction.

Further, a wireless communication method according to the present embodiments is a wireless communication method in which at least one master device executes wireless communication with at least one slave device via one communication channel that is sequentially selected from a plurality of communication channels. The wireless communication method includes: determining a communication quality of each communication channel when the at least one master device communicates wirelessly with the at least one slave device, and determines the one communication channel to be used for the wireless communication based on a determination result of the communication quality of each communication channel; causing the at least one master device to transmit a channel map indicating a determined one communication channel to the at least one slave device, and causing the at least one master device and the at least one slave device to share the channel map, the channel map shared between the at least one master device and the at least one slave device being periodically updated; and changing an update cycle of the channel map shared between the at least one master device and the at least one slave device in accordance with a communication state of the wireless communication between the at least one master device and the at least one slave device or an external instruction.

Further, a wireless communication program according to the present embodiments is a wireless communication program for at least one master device to execute wireless communication with at least one slave device via one communication channel that is sequentially selected from a plurality of communication channels. The wireless communication program includes instructions configured to, when executed by at least one processor, to cause the at least one processor to execute: determining a communication quality of each communication channel when the at least one master device communicates wirelessly with the at least one slave device, and determines the one communication channel to be used for the wireless communication based on a determination result of the communication quality of each communication channel; causing the at least one master device to transmit a channel map indicating a determined one communication channel to the at least one slave device, and causing the at least one master device and the at least one slave device to share the channel map, the channel map shared between the at least one master device and the at least one slave device being periodically updated; and changing an update cycle of the channel map shared between the at least one master device and the at least one slave device in accordance with a communication state of the wireless communication between the at least one master device and the at least one slave device or an external instruction.

As described above, in the wireless communication system, the wireless communication method, and the wireless communication program described above, the update cycle of the channel map (which can also be defined as the channel map switching cycle) is not always constant, but the update cycle of the channel map is changed in accordance with the communication state of the wireless communication between the master device and the slave device or an external instruction. Thus, for example, when the communication state is good, the possibility of successfully sharing the channel map is increased by making the update cycle of the channel map longer than when the communication state is deteriorated. Conversely, when the communication condition is deteriorated, the update cycle of the channel map can be made shorter than when the communication conditions are good, thereby speeding up the sharing of a channel map suitable for the deteriorated communication environment. Alternatively, for example, if an anomaly occurs in a control unit that uses information transmitted or received by the wireless communication between a master device and a slave device, an external instruction can be generated to shorten the update cycle of the channel map, thereby restricting the occurred anomaly from being exacerbated due to the anomaly in the wireless communication.

The reference signs and/or numerals in parentheses are merely added to indicate examples of correspondence relationships with concrete structures in the below-described embodiments in order to facilitate the understanding of the present disclosure, which has no intention to limit the scope of the present disclosure in any manner.

Technical features described in the following sections other than the above-mentioned features become apparent from the description of the embodiments and the accompanying drawings.

Hereinafter, preferred embodiments of the present disclosure will be described with reference to the drawings. Note that the same or similar components are denoted by the same reference symbols throughout multiple drawings, and description thereof may be omitted. When only a part of a configuration is described in each embodiment, the configurations of other embodiments previously described can be applied to the other parts of the configuration. In addition, not only a combination of configurations explicitly specified in the description of each embodiment but also configurations of a plurality of embodiments can be partially combined even if not explicitly specified as long as there is no problem in the combination.

### First Embodiment

A wireless communication system according to the present embodiment includes at least one master device and at least one slave device. At least one of the master device and the slave device may be used while being mounted on a mobile body. The mobile body include, for example, a vehicle such as an automobile and a railroad vehicle, a flying object such as an electric vertical take-off and landing aircraft and a drone, a ship, a construction machine, and a agricultural machine.

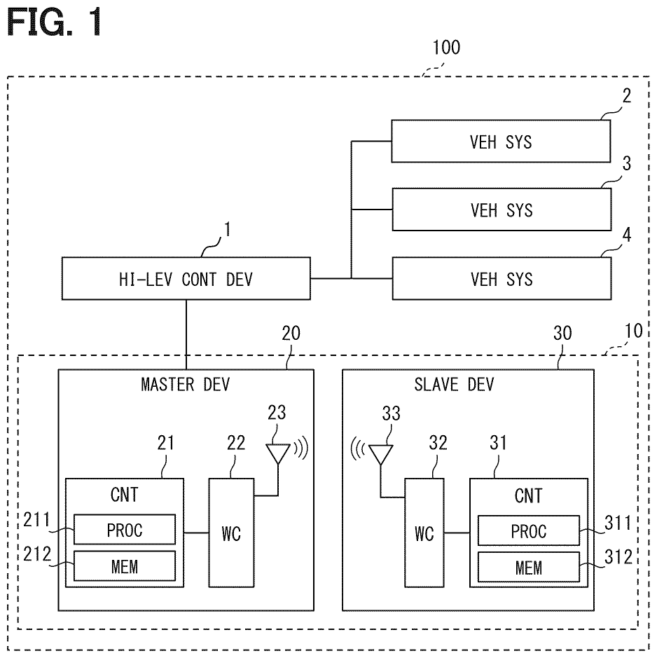

FIG. 1 shows an example of the configuration of a wireless communication system 10 according to this embodiment applied to a vehicle. As a specific application in vehicles, the wireless communication system 10 according to the present embodiment is applied to a battery management system that manages batteries mounted as battery packs in electrified vehicles, such as, for example, electric vehicles, hybrid vehicles, and plug-in hybrid vehicles and the like. When applied to a battery management system, for example, at least one master device 20 is connected to a higher-level control device (i.e., battery control device) 1, and at least one slave device 30 is connected to a monitoring device (not shown) provided in at least one battery stack that constitutes a battery pack. In this case, both the master device 20 and the slave device 30 are mounted on the vehicle.

The monitoring device provided in the battery stack acquires battery information such as the voltage and current of each battery cell included in the corresponding battery stack and the temperature of the battery stack using various sensors and the like. When the monitoring device receives data requesting the battery information from the battery control device 1 via the wireless communication system 10, the monitoring device transmits the acquired battery information to the battery control device 1 via the wireless communication system 10. The battery control device 1 calculates the state of charge (SOC) of the entire cell stack based on the acquired battery information, drives the temperature raising and cooling mechanism in order to adjust the temperature of the battery pack to an appropriate range, and determines whether to execute a so-called equalization process of equalizing the voltages of each battery cell. The battery control device 1 instructs the corresponding monitoring device to execute the equalization process via the wireless communication system 10 when a determination is made that it is necessary to execute the equalization process on at least one cell stack. The monitoring device performs a process of determining anomaly in various sensors or anomaly in the monitoring device's own operations and transmits anomaly information to the battery control device 1 via the wireless communication system 10 when an anomaly is determined.

Alternatively, the wireless communication system 10 according to the present embodiment may be applied to a so-called smart key system (registered trademark, same as below) or a tire air pressure monitoring system in a vehicle. When applied to a smart key system, for example, the master device 20 is mounted on the vehicle and connected to a control device (as the higher-level control device) 1 that controls the locking and unlocking of vehicle doors and turning on and off a driving source such as a vehicle engine. At least one slave device 30 is mounted on a mobile key or mobile terminal held by at least one user. When applied to a tire air pressure monitoring system, the master device 20 is mounted on the vehicle and connected to a control device (as the higher-level control device) 1 that displays tire pressure or issues warnings or the like when air pressure is abnormal. The multiple slave devices 30 are connected wirelessly or wired-connection to an air pressure detection device provided within each tire.

The wireless communication system 10 according to the present embodiment may be applied to a vehicle diagnostic system. In this case, for example, the multiple slave devices 30 are connected to multiple in-vehicle equipment equipped with a self-diagnosis function, and the master device 20 is connected to a diagnostic control device (as the higher-level control device) installed at a service factory. In these examples, at least one of the master device 20 and the multiple slave devices 30 is disposed at a fixed position, and/or at least one is mounted on the vehicle.

Here, application examples of the communication system 10 according to the present embodiment are not limited to vehicles, alternatively, the communication system may be application to systems that control and manage various equipment in mobile objects other than vehicles, i.e., objects including aerial object such as drones, ships, construction machinery, agricultural machinery and the like. Furthermore, the communication system 10 according to the present embodiment is also application to a system for controlling and managing various types equipment in a structure such as buildings and production facility such as factories.

In the embodiment described below, an example will be described in which the wireless communication system 10 is applied to a battery management system for managing a battery mounted on a vehicle. The wireless communication system 10 includes a master device 20 and a slave device 30, both of which are mounted on, for example, a vehicle (i.e., automobile) as shown in FIG. 1. At this time, the master device 20 and the slave device 30 may be disposed in a common housing of a battery pack or may not be disposed in a common housing. The number of master devices 20 may be one or more. When multiple master devices 20 are provided, each of the multiple master devices 20 may communicate with at least one slave device 30 belonging to a different group. Alternatively, the multiple master devices 20 may communicate with at least one slave device 30 belonging to the same group. The master device 20 and the slave device 30 execute the wireless communication via a communication channel, which is sequentially selected from multiple communication channels, under Bluetooth Low Energy (Bluetooth is a registered trademark, same as below, and the Bluetooth Low Energy is referred to as Bluetooth LE) communication.

For the wireless communication between the master device 20 and the slave device 30, a frequency band, for example, the 2.4 GHz, the 5 GHz, or the like for a short-range communication can be used. Such electric waves in the high frequency band have higher straightness than electric waves in the low frequency band, and are likely to be reflected by a metal body such as a vehicle body. LF is an abbreviation for Low Frequency. As the short-range communication standards, for example, Bluetooth, Bluetooth LE, or the like can be adopted. As an example, the master device 20 and the slave device 30 of the present embodiment are configured to be capable of performing wireless communication (hereafter, referred to as Bluetooth LE communication) based on the Bluetooth LE standard. Details of the communication method related to communication connection, encrypted communication, and the like are performed according to the sequence defined by the Bluetooth LE standard.

The master device 20 includes a control circuit (i.e., CNT) 21, a wireless communication circuit (i.e., WC) 22, and an antenna 23, as shown in FIG. 1. In addition to the above-described elements, the master device 20 includes an input-output interface or a bus line for wired or wireless communication with devices other than the slave device 30. Here, processing such as a channel map control process, a channel map generation process, a channel map update cycle setting process and a channel map share process, which will be described later, may be performed by the control circuit 21, or a part or all of these processing may be performed by a separate control device (for example, the higher-level control device 1) disposed outside of the master device 20.

The control circuit 21 is, for example, a computer including a processor 211 and a memory 212. The memory 212 includes, for example, RAM and ROM. The RAM is an abbreviation for Random Access Memory. The ROM is abbreviation for Read Only Memory.

The processor 211 of the control circuit 21 executes a predetermined process (i.e., a control process) by executing a program stored in the ROM while using the RAM as a temporary storage area. The processor 211 constructs multiple functional units by executing multiple instructions included in the program. There may be a plurality of processors 211. The program storage medium is not limited to the ROM. For example, various storage media such as HDD and SSD can be adopted. The HDD is an abbreviation for Hard-Disk Drive. The SSD is an abbreviation for Solid State Drive.

The processor 211 is, for example, a CPU, a MPU, a GPU, a DFP, or the like. CPU is an abbreviation for Central Processing Unit. MPU is an abbreviation for Micro-Processing Unit. GPU is an abbreviation for Graphics Processing Unit. DFP is an abbreviation for Data Flow Processor. The control circuit 21 may be implemented by combining multiple types of calculation processing units such as a CPU, an MPU, and a GPU. Alternatively, the control circuit 21 may be realized as an SoC. The SoC is an abbreviation for System on Chip. The control circuit 21 may be realized using ASIC or FPGA. ASIC is an abbreviation for Application Specific Integrated Circuit. The FPGA is an abbreviation for Field-Programmable Gate Array.

The control circuit 21 generates a command for requesting the slave device 30 to perform process (for example, a command for requesting data, a command for requesting execution of predetermined process, or the like), and transmits transmission data including the command to the wireless communication circuit 22 as a transmission packet. Further, the control circuit 21 receives a packet transmitted from the slave device 30 via the wireless communication circuit 22, and executes a predetermined process such as a process for transferring data to the higher-level control device 1 and the like based on the data included in the received packet. The wireless communication performed by the master device 20 and the slave device 30 is packet communication.

The wireless communication circuit 22 includes a RF circuit (not shown) for wirelessly transmitting and receiving the packet. The wireless communication circuit 22 has a transmission function of modulating a transmission signal and oscillating the signal at the frequency of an RF signal. The wireless communication circuit 22 has a receiving function of demodulating the received signal. RF is an abbreviation for Radio Frequency.

The wireless communication circuit 22 modulates the packed including the data transmitted from the control circuit 21, and transmits the packet to the slave device 30 via the antenna 23. The control circuit 21 outputs, to the wireless communication circuit 22, data obtained by encrypting transmission data such as battery information request data using, for example, encryption information exchanged in a connection establishment process described later. The wireless communication circuit 22 can add data (for example, communication control information) necessary for the wireless communication, to the transmission packet, and transmits the data. The data necessary for the wireless communication includes, for example, an identifier (ID), a sequence number, a next sequence number, an error detection code, and the like. The wireless communication circuit 22 may control data size, communication format, schedule, error detection, or the like of communication between the master device 20 and the slave device 30. The control related to these communications may be performed by the control circuit 21.

The wireless communication circuit 22 receives the packet transmitted from the slave device 30 via the antenna 23 and demodulates the packet. The demodulated packet is transmitted to the control circuit 21. The antenna 23 converts electrical signals into radio waves and radiates the radio waves into space. The antenna 23 receives a electric wave propagating in space and converts the electric wave into an electric signal.

The slave device 30 includes a control circuit (i.e., CNT) 31, a wireless communication circuit (i.e., WC) 32, and an antenna 33, as shown in FIG. 1. In addition to the above-described elements, the slave device 30 includes an input-output interface or a bus line for wired or wireless communication with devices other than the master device 20. The control circuit 31 has the similar configuration to the control circuit 21 of the master device 20. The control circuit 31 includes, for example, a processor 311 and a memory 312. The memory 312 includes, for example, a RAM and a ROM.

The control circuit 31 performs the requested processing (e.g., the response processing for obtaining and returning requested data, execution processing of the requested processing, and the like) based on the request command acquired via the wireless communication circuit 32. For example, when the requested command, which is included in the received data, is a transmission request for the battery information, the control circuit 31 of the slave device 30 transmits the transmission request to the monitoring device of the corresponding cell stack and acquires the battery information from the monitoring device, and as a response to the request, the control circuit 31 transmits data, which is encrypted by using the encryption information including processing result (for example, the acquired battery information), to the wireless communication circuit 32. The control circuit 31 can also control, for example, equipment mounted on a vehicle according to requested processing.

The wireless communication circuit 32 includes a RF circuit (not shown) for wirelessly transmitting and receiving the packet. The wireless communication circuit 32, like the wireless communication circuit 22, has a transmission function and a receiving function. The wireless communication circuit 32 receives the packet transmitted from the master device 20 via the antenna 33 and demodulates the packet. The data, which is included in the demodulated packet, is transmitted to the control circuit 31. The wireless communication circuit 32 modulates the packet containing data transmitted from the control circuit 31 and transmits the packet to the master device 20 via the antenna 33. The wireless communication circuit 32 adds data required for the wireless communication, such as communication control information, to the transmission packet, and transmits the packet.

The wireless communication circuit 32 may control the data size, the communication format, the schedule, the error detection, and the like of communication between the master device 20 and the slave device 30. The control related to these communications may be performed by the control circuit 31. The antenna 33 converts electrical signals into radio waves and radiates the radio waves into space. The antenna 33 receives an electric wave propagating in space and converts the electric wave into an electric signal.

The higher-level control device 1 is configured to be able to communicate with other vehicle systems 2, 3, and 4 via an in-vehicle LAN such as a Controller Area Network or a Local Interconnect Network. The other vehicle systems 2, 3, and 4 are, for example, a navigation system equipped with a communication function with an external management center for updating map data and setting destinations, an ETC system (ETC is a registered trademark, the same applies below) that automatically collects tolls and other fees via wireless communication with the outside, an airbag system that protects occupants in the event of a vehicle collision, and a collision mitigation system that avoids or reduces collisions with obstacles. The higher-level control device 1 receives external instructions from these other vehicle systems 2, 3, and 4 to change the update cycle of the channel map, as will be described in detail later.

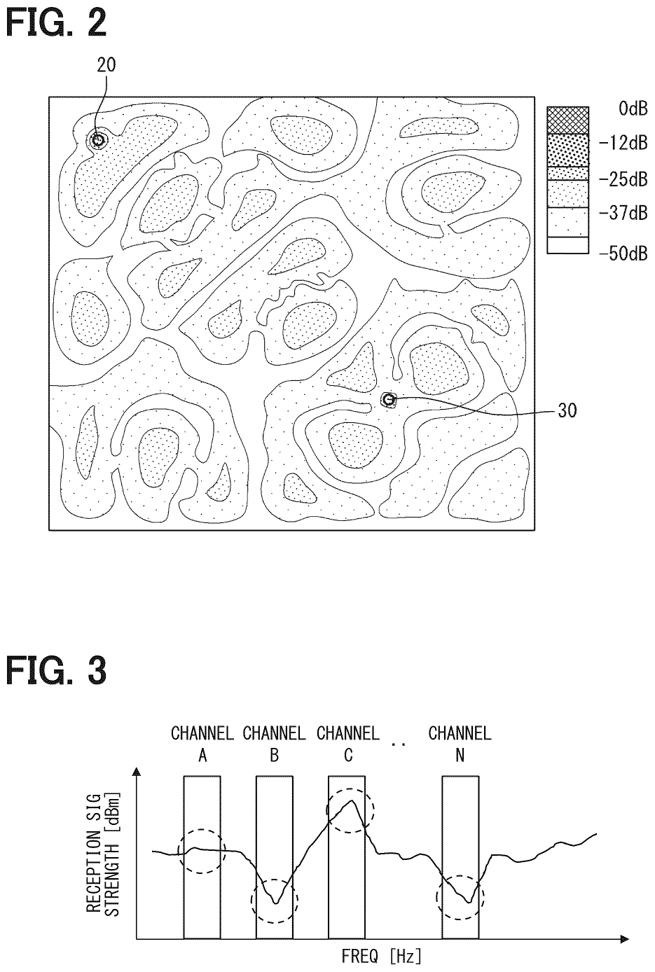

FIG. 2 is a diagram showing one example of the electric field strength distribution of the communication environment between the master device 20 and the slave device 30. FIG. 2 shows an electromagnetic field simulation result at a predetermined frequency and at predetermined time. In the following, the electric field strength distribution may be referred to as electric field distribution.

The master device 20 and the slave device 30 are arranged at predetermined positions in the vehicle, for example. When a wireless radio wave signal is transmitted at a predetermined frequency from the master device 20 and the slave device 30, which are respectively disposed at predetermined positions, a portion with high electric field intensity and a portion with low electric field intensity are generated in usage environment due to interference between transmission waves and reflected waves or interference with external noise. The reflected waves are caused by reflection from metal elements of the vehicle that are present around the master device 20 and the slave device 30, such as reflection from the vehicle body, reflection from a metal housing, reflection from a harness, and the like. For this reason, the communication environment between the master device 20 and the slave device 30 has a plurality of so-called NULL points, which are portions with high electric field strength and portions with low electric field strength, as shown in FIG. 2.

When the slave device 30 is located in or near a portion with the low electric field strength in the electric field distribution with the master device 20, there is a high possibility that the slave device 30 will not be able to properly receive the wireless signal from the master device 20, so that a communication error may occur. A communication channel where such a communication error is likely to occur is a communication channel where communication quality has reduced.

Here, when the master device 20 and the slave device 30 perform the wireless communication via one communication channel sequentially selected from a plurality of communication channels, each communication channel has a different frequency, so that the electric field distribution of each communication channel may also change. As a result, the communication quality may vary between communication channels.

For example, as shown in FIG. 3, in the wireless communication via the communication channel A, reception power (i.e., reception signal strength), which is one of the parameters indicating the communication quality, is excellent. In the wireless communication via Communication Channel C, the received electric power shows a very high value. Therefore, when the master device 20 and the slave device 30 use Communication Channels A and C with good or very high communication quality, high quality wireless communication with sufficiently limited communication errors may be performed. On the other hand, in the wireless communication via Communication Channels B and N, the received electric power is low. Therefore, when the master device 20 and the slave device 30 use communication channels B and N having deteriorated communication quality, there is a high possibility that a communication error occurs in the wireless communication. Here, in FIG. 3, in order to facilitate understanding, an example of received signal strength with respect to frequency is shown by a solid line.

Therefore, it may be preferable that the wireless communication between the master device 20 and the slave device 30 is performed using a communication channel that can perform the high quality wireless communication, avoiding a communication channel where the communication quality has reduced.

Here, the electric field distribution between the master device 20 and the slave device 30 changes depending on the external environment (such as external noise, and the like), the vibration of the master device 20 and/or the slave device 30 (including the vibration of the harness), and the like. Therefore, when the master device 20 and the slave device 30 are mounted in a vehicle, the electric field distribution of the communication environment between the master device 20 and the slave device 30 changes depending on, for example, the state of the vehicle (e.g., running state or stopped state) and the state of the vehicle. It changes depending on the state of the surrounding environment (for example, whether there is a lot of external noise or little external noise). As a result, the communication channels with excellent communication quality and the communication channels with reduced communication quality are not fixed and may change from time to time. Therefore, in response to a reduction in the communication quality, the corresponding communication channel is deleted from multiple communication channels used for the wireless communication, and in response to the recovery of communication quality, the corresponding communication channel is restored as one of multiple communication channels used for the wireless communication.

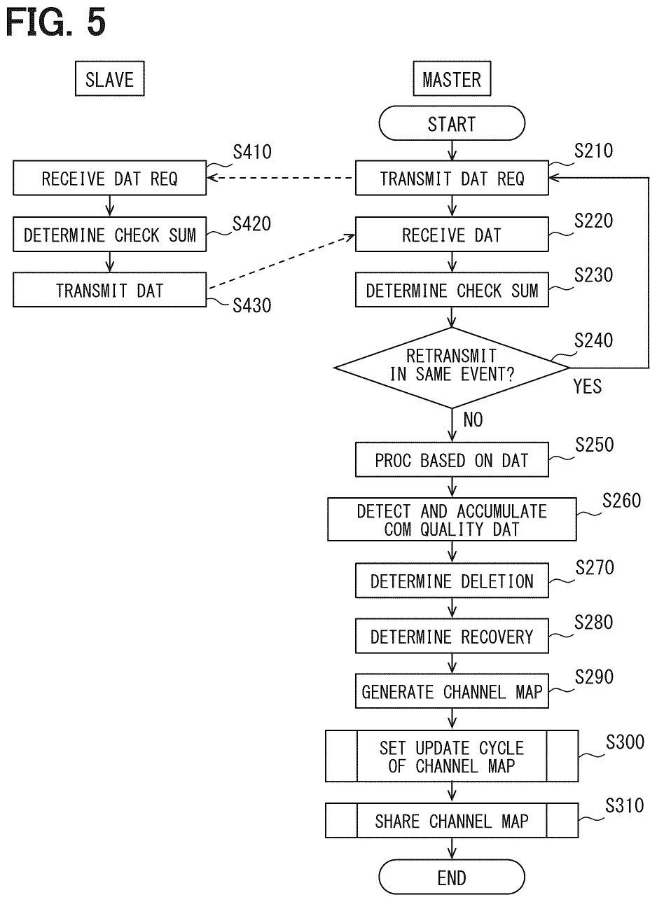

In the wireless communication system 10 of the present embodiment, as a plurality of communication channels used for wireless communication, a part of the communication channels in which a certain communication quality is ensured are used, other than a communication channel in which the communication quality is reduced due to channel map control, so that a control process for realizing the wireless communication between the master device 20 and the slave device 30 will be explained with reference to a drawing showing a communication sequence between the master device 20 and the slave device 30 shown in FIG. 5. In FIG. 5, the master device 20 is indicated as MASTER, and the slave device 30 is indicated as SLAVE. Here, FIG. 5 shows a communication sequence executed between the master device 20 and one slave device 30. When providing a plurality of slave devices 30, the master device 20 individually executes the communication sequence shown in FIG. 5 with the plurality of slave devices 30.

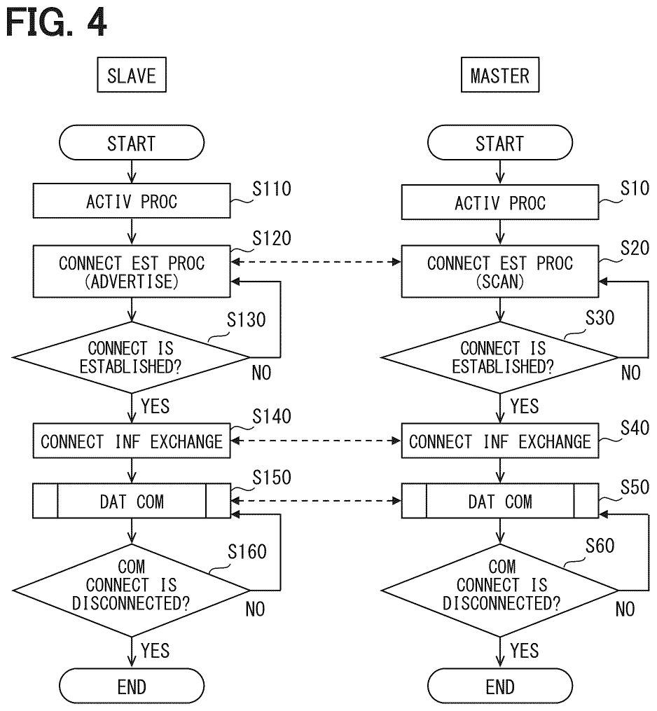

Here, the master device 20 and the slave device 30 execute a connection establishment process before executing the communication sequence shown in FIG. 5. FIG. 4 shows an example of an activation sequence including the connection establishment process executed between when the master device 20 and the slave device 30 are activated and when data communication is performed. For example, when the wireless communication system 10 is mounted in a vehicle, an activation sequence is started when the IG signal is switched from the off state to the on state, for example, by a user's operation. Here, when the master device 20 and the slave device 30 are always connected, the activation sequence is performed only once at a predetermined timing. Here, if an error occurs during the communication and the wireless communication connection between the master device 20 and the slave device 30 is disconnected, the activation sequence may be performed for reconnection.

When the activation sequence is started, the master device 20 and slave device 30 execute an activation process including an initialization process to initialize various variables, timers, and the like in steps S10 and S110, respectively. Thereafter, the master device 20 and slave device 30 execute the connection establishment process in steps S20 and S120, respectively. This connection establishment process is executed in each of the master device 20 and all the slave devices 30 when a plurality of slave devices 30 are provided. In the connection establishment process, the slave device 30 may execute an advertising operation of transmitting an advertising signal via a communication channel for advertising purpose, and the master device 20 may execute a scanning operation for scanning the advertising signal. The communication channel for advertising includes a plurality of communication channels (for example, three in the case of Bluetooth LE). When the master device 20 receives an advertising signal through one of the communication channels through a scanning operation, the master device 20 transmits a connection request to the slave device 30 that has transmitted the advertising signal. Thereby, a communication connection is established between the master device 20 and the slave device 30. When the master device 20 and the slave device 30 determine in steps S30 and S130, respectively, that the communication connection has been established, the master device 20 proceeds to step S40, and the slave device 30 proceeds to step S140.

The master device 20 and slave device 30 exchange connection information in steps S40 and S140, respectively. In this exchange of the connection information, the master device 20 and the slave device 30 exchange encryption information used for the data communication and execute a share process for sharing the initial information regarding frequency channel hopping. The initial information includes, for example, an initial channel map, a hopping pattern or a function for hopping.

Next, in steps S50 and S150, respectively, the master device 20 and the slave device 30 execute the data communication via a data communication channel sequentially selected from a plurality of communication channels for each communication event that occurs periodically. A process for performing this data communication is shown in the communication sequence of FIG. 5.

When the master device 20 and the slave device 30 determine to disconnect the communication connection in steps S60 and S160, respectively, the master device 20 and the slave device 30 end the activation sequence shown in FIG. 4. For example, when the wireless communication system 10 is mounted in a vehicle, the master device 20 and the slave device 30 may determine to disconnect the communication connection when the IG signal is switched from the on state to the off state by a user operation. Further, the master device 20 and the slave device 30 may determine to disconnect the communication connection when the data communication cannot be performed normally a predetermined number of times in succession or the like.

Next, the communication sequence of the data communication will be explained with reference to the flowchart of FIG. 5. As shown in FIG. 5, the master device 20 transmits, for example, a data request command, that is, a data request, to the slave device 30 in step S210. Here, in addition to the data request, the master device 20 can also transmit, for example, a request to execute a predetermined process. When the slave device 30 receives the data request in step S410, in step S420, the slave device 30 performs, for example, a checksum determination based on the error detection code included in the received data request in order to confirm whether or not the data request has been properly received. When the slave device 30 determines in the process of step S420 that the data request cannot be received properly based on the checksum determination result, for example, in step S430, the slave device 30 transmits a signal indicating that the data request cannot be received properly, or a signal for requesting retransmission of the data request. On the other hand, when the slave device 30 determines in the process of step S420 that the data request has been properly received, in step S430, the slave device 30 performs a predetermined process necessary for response, for example, a process of acquiring and transmitting the requested data.

Here, the master device 20 and the slave device 30 perform frequency channel hopping to switch data communication channels to be used for each communication event, and transmit and receive data requests and requested data. At this time, the master device 20 and the slave device 30 determine the communication channel to be switched by the frequency channel hopping, according to the channel maps that each of the master device 20 and the slave device 30 stores. Here, in the case of Bluetooth LE communication, thirty-seven communication channels are prepared as data communication channels.

The master device 20 receives the requested data in step S220. Then, in step S230, the master device 20 performs, for example, a checksum determination based on the error detection code included in the received data, in order to confirm whether the data has been properly received. In the following step S240, the master device 20 determines whether or not to execute processing for retransmission within the same communication event when it is determined in the process of step S230 that the data cannot be received correctly or when a signal indicating that the data request cannot be received correctly is received from the slave device 30. For example, the master device 20 may determine execution of retransmission when there is enough time to perform retransmission until the end time of the current communication event, and may determine non-execution of retransmission when there is no enough time until the end time of the current communication event. In step S240, when the master device 20 determines to perform retransmission, the master device 20 executes the process from step S210 again. When it is determined that the data is correctly received in step S230 or it is determined that the retransmission of data is not executed in step S240, the master device 20 proceeds to step S250.

In step S250, the master device 20 executes a process based on the information included in the received data. Here, if it is determined in the process of step S230 that the data has not been received correctly, or if a signal indicating that the data request has not been correctly received is received from the slave device 30, and it is determined in the process of step S240 that the retransmission is not performed, the process in step S250 may be omitted, or the process in step S250 may be executed based on previously received data.

In S260, the master device 20 detects the communication quality data indicating the communication quality such as the received signal strength (RSSI) and the packet error rate (PER) as the characteristic data indicating the communication quality of the signal received from the slave device 30. The RSSI is an index indicating the strength of a signal transmitted from the slave device 30 and received by the master device 20. The PER indicates a ratio of the number of error packets to the number of received packets received by master device 20 in percentage. The master device 20 may detect signal noise ratio (SNR)/signal interference noise ratio (SINR), instead of the RSSI. The SNR/SINR may be detected by, for example, a ratio between an RSSI value when the master device 20 receives a radio signal from the slave device 30 and an RSSI value when the master device 20 does not receive a radio signal. Furthermore, the master device 20 may detect the bit error rate (BER) or the packet arrival rate (PAR) instead of the PER. The master device 20 stores and accumulates the detected RSSI or SNR/SINR, and PER, BER or PAR, for each communication channel. In addition to or instead of the detection by the master device 20 as described above, the communication quality data may also be acquired by the slave device 30. The slave device 30 may detect an RSSI, a PER, or the like from a received signal transmitted from the master device 20, and transmit the detected RSSI, the PER, or the like to the master device 20.

In step S270, the master device 20 determines whether the communication quality of the communication channel used for wireless communication with the slave device 30 has been reduced based on the communication quality data of the communication channel detected in step S260. Then, the master device 20 excludes the communication channel whose communication quality is determined to be reduced from the communication channels to be used for the wireless communication between the master device 20 and the slave device 30. The excluded communication channel is a communication channel for data. For example, an example of a condition for determining the reduction in the communication quality is that the RSSI is compared with a threshold value for the RSSI, and the PER is compared with a threshold value for the PER, and as a result, at least one of the RSSI and the PER is not satisfied with a condition of the threshold value. Here, the number of parameters to be compared with the threshold value may be one. Alternatively, the parameter to be compared with the threshold value may be the immediately preceding parameter detected in step S260, or may be an average or a center value of a predetermined number of parameters detected in multiple past wireless communications regarding the same communication channel.

In step S280, the master device 20 executes restoration determination of the excluded communication channel based on the exclusion determination at the time of the previous communication event. In this restoration determination, if a predetermined restoration condition is met, the excluded communication channel is restored as a communication channel to be used for wireless communication. For example, as an example of the predetermined restoration condition, an excluded communication channel may be restored when a predetermined period of time has elapsed since the communication channel was excluded. Alternatively, as another example of the predetermined restoration condition, in response to a communication channel adjacent to the excluded communication channel showing the excellent communication quality, the excluded communication channel may be restored as a communication channel to be used for wireless communication. In this way, the communication channel determined to be able to restore as a communication channel to be used for wireless communication is incorporated into the channel map and actually used for wireless communication between the master device 20 and the slave device 30. The exclusion determination process in step S270 and the restoration determination process in step S280 correspond to the channel map control process in the present embodiment. Here, if the communication quality of the communication channel that has been determined to be restored remains to be reduced when the communication channel is actually used for wireless communication, the communication channel may be a target of exclusion again by the exclusion determination.

In step S290, the master device 20 performs channel map generation processing based on the exclusion determination result in step S270 and the restoration determination result in step S280.

The channel map may indicate communication channels that can be used for wireless communication, or may indicate communication channels that cannot be used for wireless communication. The channel map may indicate both the usable communication channel and the unusable communication channel. When there is a change in the usable/unusable communication channels due to the creation of the channel map, a frequency channel hopping pattern may be updated. When the frequency channel hopping pattern is not updated or when the communication channel to be hopped cannot be used, the communication channel to be hopped for next communication event may be used.

In step S300, the master device 20 executes a channel map update cycle setting process. This channel map update cycle setting process will be explained in detail later.

In step S310, the master device 20 executes a process for sharing the channel map generated by the channel map generation process in step S290 with the slave device 30. This channel map sharing process will be explained in detail later.

Here, the above-described exclusion determination process and the restoration determination process may be performed every time the communication is performed between the master device 20 and the slave device 30. Alternatively, the exclusion determination process and the restoration determination process may be performed all at once, each time a plurality of communications are performed between the master device 20 and the slave device 30, in accordance with the channel map update cycle described below. In this case, each time the communication is performed between master device 20 and slave device 30, characteristic data indicating the communication quality of the communication channel used for communication is detected and accumulated in step S260. Then, based on the accumulated characteristic data, the exclusion determination in step S270 and the restoration determination in step S280 are performed together. Similarly, the channel map generation process in step S290 may be performed every time the communication is performed between the master device 20 and the slave device 30. Alternatively, the channel map generation process may be performed every time the communication is performed between the master device 20 and the slave device 30 a plurality of times in accordance with a channel map update cycle to be described later.

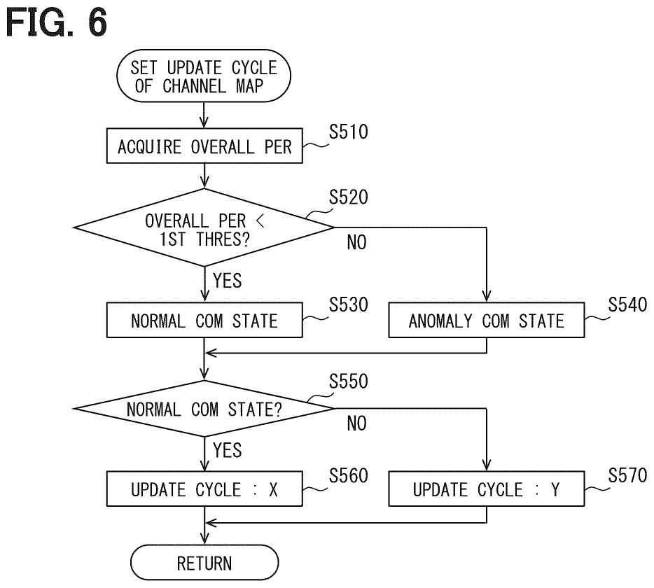

Next, the above-mentioned channel map update cycle setting process will be described with reference to the flowchart of FIG. 6. The flowchart in FIG. 6 shows an example of the channel map update cycle setting process. In this embodiment, an example will be described in which, in the channel map update cycle setting process, the channel map update cycle is set (or changed) depending on the communication state of wireless communication between the master device 20 and the slave device 30.

In the first step S510, the master device 20 acquires an overall PER, which indicates a communication error rate, as an index indicating the communication state of the wireless communication with the slave device 30. For example, the master device 20 acquires the overall PER by calculating the average or median value of the PERs of a predetermined number of recent wireless communications, including the most recent wireless communication with the slave device 30. In this case, the individual PERs used to calculate the average or median value are acquired through the wireless communication via a plurality of different communication channels. The master device 20 may use BER or PAR as an index indicating the communication state of the wireless communication with the slave device 30.

In step S520, the master device 20 compares the acquired overall PER with a first threshold value (i.e., communication error rate threshold value) to specify whether the communication status of the wireless communication between the master device 20 and the slave device 30 is a good normal communication state or an anomaly communication state in which the communication state has deteriorated. In other words, if the acquired overall PER is less than the first threshold value, the communication error rate is relatively low, and the communication state can be regarded as a normal communication state. In this case, the process proceeds to step S530, where the master device 20 determines that the communication state of the wireless communication between the master device 20 and the slave device 30 is in a normal state. On the other hand, if the acquired overall PER is equal to or greater than the first threshold value, the communication error rate is relatively high, and the communication state can be regarded as an anomaly communication state. In this case, the process proceeds to step S540, where the master device 20 determines that the communication state of the wireless communication between the master device 20 and the slave device 30 is in an anomaly state.

In step S550, the master device 20 determines whether the communication state of the wireless communication between the master device 20 and the slave device 30 is in a normal state or in an anomaly state, based on the identification result of the communication state. If it is determined that the communication is in the normal state, the master device 20 proceeds to step S560 and sets the channel map update cycle to X. If it is determined that the communication is in the anomaly state, the master device 20 proceeds to step S570 and sets the channel map update cycle to Y. Here, the relationship of “the update cycle X>the update cycle Y” is established. That is, the master device 20 sets the channel map update cycle of Y when the overall PER is equal to or greater than the first threshold value to be shorter than the channel map update cycle X when the overall PER is less than the first threshold value. In this case, in order to prevent the update cycle from becoming too short, it may be preferable that the master device 20 sets the channel map update cycle Y to be shorter than the channel map update cycle X, as long as the channel map update cycle Y is equal to or greater than the predetermined minimum cycle. On the other hand, in order to prevent the update cycle X from becoming too long, it may be preferable that the master device 20 sets the channel map update cycle X to be longer than the channel map update cycle Y, as long as the update cycle X is equal to or less than a predetermined maximum cycle.

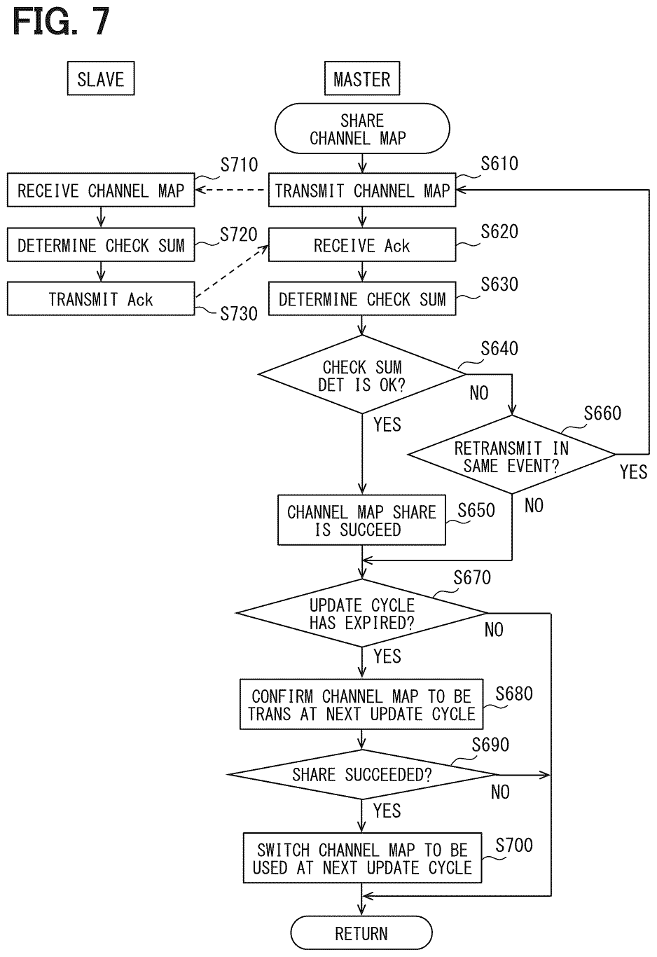

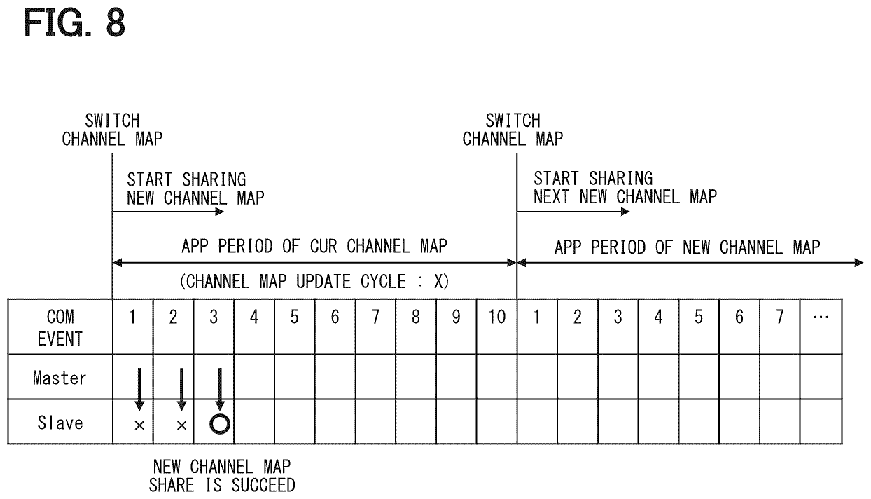

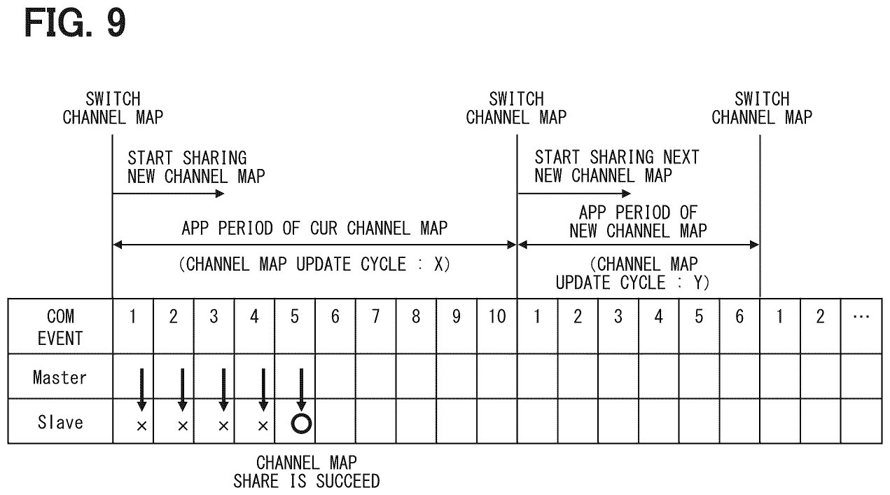

Next, the above-mentioned channel map share process will be described with reference to the flowchart of FIG. 7 and the time charts of FIGS. 8 and 9. The flowchart in FIG. 7 shows an example of the channel map sharing process. FIG. 8 is a time chart showing an example of the operation of a channel map sharing process when the update cycle of the channel map is set to X cycles. FIG. 9 is a time chart showing an example of the operation of a channel map sharing process when the update cycle of the channel map is switched from X cycles to Y cycles.

As shown in the time chart of FIG. 8, for example, the new channel map sharing process is started during the application period of the current channel map. In other words, the new channel map is generated by a channel map generation process based on multiple communication quality data detected before the application period of the current channel map (i.e., the start of sharing the new channel map), and is confirmed as a new channel map before the application period of the current channel map. Furthermore, the next new channel map is confirmed before the application period of the new channel map, based on the communication quality data detected from the communication between the master device 20 and the slave device 30 during the application period of the current channel map.

The channel map share process in the flowchart of FIG. 7 is for causing the master device 20 and the slave device 30 to share a new channel map for each channel map update cycle X or Y, as shown in the time charts of FIGS. 8 and 9. In the first step S610, the master device 20 transmits to the slave device 30 the new channel map that was confirmed before the start of sharing the new channel map. At this time, the master device 20 transmits the new channel map as well as information indicating the timing to start using the new channel map. The timing to start using the new channel map comes every time the channel map update cycle elapses, as in the example shown in the time chart of FIGS. 8 and 9. The timing to start using the new channel map can be calculated based on the channel map update cycle set in the channel map update cycle setting process of FIG. 6. The timing to start using the channel map is also confirmed before the start of sharing the new channel map, similar to the new channel map. As shown in the timing chart of FIG. 8, if the new channel map is successfully shared, the new channel map and the timing information do not need to be transmitted in subsequent communication events. In FIGS. 8 and 9, an mark “x” indicates a failure in sharing the channel map, and a mark “o” indicates a success in sharing the channel map.

In step S710, the slave device 30 receives the new channel map and the timing information transmitted from the master device 20. When the slave device 30 receives the new channel map and the timing information in step S710, in step S720, the slave device 30 performs the check sum determination based on the error detection code included in the received packet in order to confirm whether or not the new channel map and the timing information have been correctly received. If the slave device 30 determines in step S720 that the new channel map and the timing information have not been correctly received based on the check sum determination result, for example, in step S730, the slave device 30 does not transmit a reception confirmation signal (i.e., acknowledgement signal or Ack signal) of the new channel map. On the other hand, if the slave device 30 determines in step S720 that the new channel map and the timing information have been correctly received, the slave device 30 returns a reception confirmation signal (i.e., Ack signal) for the new channel map to the master device 20 in step S730.

In S620, the master device 20 receives the Ack signal transmitted from the slave device 30. In S630, the master device 20 performs, for example, checksum determination based on the error detection code included in the received Ack signal in order to confirm whether the Ack signal has been correctly received. Here, if the master device 20 cannot receive the Ack signal itself, the result of the check sum determination will be not-good, i.e., NG. In the following step S640, the master device 20 determines whether the result of the check sum determination in step S630 is OK or NG. If the check sum determination result is OK, the master device 20 proceeds to step S650. On the other hand, if the result of the check sum determination is NG, the master device 20 proceeds to step S660.

In step S650, the master device 20 determines that the channel map has been successfully shared because the ACK (i.e., acknowledgement) signal has been received correctly. On the other hand, in step S660, since the ACK signal has not been correctly received, the master device 20 determines whether to execute processing for retransmission within the same communication event. In step S660, when the master device 20 determines to perform retransmission, the master device 20 executes the process from step S610 again. If it is determined in step S660 not to perform retransmission, the master device 20 proceeds to step S670.

In step S670, the master device 20 determines whether the channel map update cycle has expired. For example, as shown in the example of the time chart of FIG. 8, if the update cycle X is set to a length equivalent to 10 communication events, the channel map update cycle X is determined to have expired when ten communication events have been executed since the channel map update cycle X started. If it is determined in step S670 that the update cycle has expired, the master device 20 proceeds to step S680. On the other hand, if it is determined that the update cycle has not expired, the master device 20 ends the channel map share process shown in FIG. 7.

In step S680, the master device 20 confirms the channel map to be transmitted in the next update cycle based on the channel map generated in step S290 in the communication sequence of FIG. 5. At this time, the master device 20 also confirms the timing to start using the channel map to be transmitted in the next update cycle, based on the channel map update cycle set in the channel map update cycle setting process of FIG. 6. In the next step S690, the master device 20 determines whether or not the channel map was successfully shared during the expired update cycle. That is, if it is determined in step S650 that the sharing of the channel map has been successful, the master device 20 determines in step S690 that the sharing has been successful. On the other hand, if it is not determined in step S650 that the channel map has been successfully shared, the master device 20 determines in step S690 that the sharing has failed. If it is determined that the sharing has been successful, the master device 20 proceeds to step S700. If it is determined that the sharing has failed, the master device 20 ends the channel map share process shown in FIG. 7. In step S700, the master device 20 switches the channel map to be used in the next update cycle to the channel map that has been successfully shared. As a result, as shown in the time chart of FIG. 8, in the next update cycle, the wireless communication between the master device 20 and the slave device 30 is executed using the new channel map that has been successfully shared.

As described above, if it is determined in step S690 that the channel map sharing has failed, the master device 20 ends the channel map share process shown in FIG. 7 without switching the channel map. Therefore, in this case, the channel map is not switched in the next update cycle, and the channel map used in the previous update cycle continues to be used. If it is determined that the sharing of the channel map has failed, it is highly likely that the slave device 30 does not have a new channel map. However, it is possible that the slave device 30 was able to receive the channel map and the timing information to be used in the next update cycle, but the master device 20 was unable to properly receive the ACK signal for acknowledging receipt of the information. Therefore, regardless of whether the channel map sharing is determined to have been successful or unsuccessful, the master device 20 may switch the channel map. Then, regardless of whether the channel map is switched or not, each time an update cycle expires, the channel map to be used in the next update cycle, in other words, the channel map that is attempted to be shared, is updated to the new channel map in step S680.

Here, even if the master device 20 attempts the wireless communication with the slave device 30 while continuing to use the channel map used in the previous update cycle or while switching the channel map used in the previous update cycle, for example, if the wireless communication with the slave device 30 is not possible at all over a predetermined number of update cycles, the master device 20 and the slave device 30 may disconnect their communication connection.

When the master device 20 and the slave device 30 disconnect the communication connection, the master device 20 and the slave device 30 start the above-described activation sequence of FIG. 4 in order to reconnect the communication connection. As a result, reconnection between the master device 20 and the slave device 30 is attempted. In the activation sequence that is the reconnection process, a communication connection is established between the master device 20 and the slave device 30, and the connection information including a channel map indicating a communication channel to be used for wireless communication is shared between the master device 20 and the slave device 30. At this time, the channel map is initialized to an initial channel map in which all communication channels are used for wireless communication. This allows the master device 20 and the slave device 30 to perform the wireless communication again.

In this embodiment, as shown in the time charts of FIGS. 8 and 9, in general, the channel map shared by the master device 20 and the slave device 30 is updated every multiple communication events (e.g., six or ten communication events in the examples shown in the drawings). In other words, the channel map used for the wireless communication between the master device 20 and the slave device 30 is switched for each of a plurality of communication events. That is, the period of multiple communication events is the application period of the channel map and the channel map update cycle. In this way, by periodically updating the channel map, the master device 20 and slave device 30 can perform high-quality communication using a channel map that adapts to changes in the communication quality of each communication channel.

In particular, in the wireless communication system 10 according to this embodiment, the update cycle of the channel map is changed depending on the communication state of the wireless communication between the master device 20 and the slave device 30. If the channel map update cycle is constant, there is a possibility that the channel map may not be updated at a cycle suitable for the communication environment at any given time. For example, even if the communication environment is relatively good, it is considered that the number of times the channel map is transmitted may be not sufficient during the period between updating the channel map and updating to the next channel map, so that the sharing of the channel map may be failed. On the other hand, if a good communication environment deteriorates, due to the influence of noise, and the like, it cannot be said that the possibility of successfully sharing the channel map can be increased even if the number of times the channel map is transmitted is large.

Therefore, in the wireless communication system 10 according to this embodiment, when the communication state is good, the channel map update cycle X is set longer than when the communication state is deteriorated, as shown in the time chart of FIG. 8. This increases the probability of successful sharing of the channel map between the master device 20 and the slave device 30. On the other hand, when the communication state deteriorates, the channel map update cycle Y is set shorter than when the communication state is good, as shown in the time chart of FIG. 9. This allows for the speedy sharing of a channel map suitable for a deteriorated communication environment.

### Second Embodiment

Next, a wireless communication system 10 according to a second embodiment of the present disclosure will be described with reference to the drawings. Since the wireless communication system 10 according to the present embodiment has similar configuration to the wireless communication system 10 of the first embodiment, description of the similar configuration will be omitted.

In the wireless communication system 10 according to the first embodiment described above, the master device 20 determines whether the communication state of the wireless communication between the master device 20 and the slave device 30 is in the normal state or in the anomaly state based on the overall PER. On the other hand, in the wireless communication system 10 according to this embodiment, the master device 20 determines whether the communication state of the wireless communication between the master device 20 and the slave device 30 is in the normal state or in the anomaly state based on the number of consecutive communication failures in the wireless communication for each communication event. In this way, the communication state of the wireless communication between the master device 20 and the slave device 30 can also be determined based on the number of consecutive communication failures. Furthermore, the wireless communication system 10 according to this embodiment is configured to notify the higher-level control device 1 of the communication state of the wireless communication between the master device 20 and the slave device 30. As a result, if the communication state is in the normal state, the higher-level control device 1 can determine to use the information transmitted or received by the wireless communication between the master device 20 and the slave device 30. On the other hand, if the communication state is in the anomaly state, the higher-level control device 1 can determine not to use the information transmitted or received by the wireless communication between the master device 20 and the slave device 30, and can take measures such as temporarily suspending control based on that information or continuing control based on information transmitted or received in the past.

Hereinafter, the wireless communication system 10 according to the present disclosure will be described, focusing on the differences from the wireless communication system 10 according to the first embodiment. The wireless communication system 10 according to this embodiment differs from the wireless communication system 10 according to the first embodiment mainly in the channel map update cycle setting process.

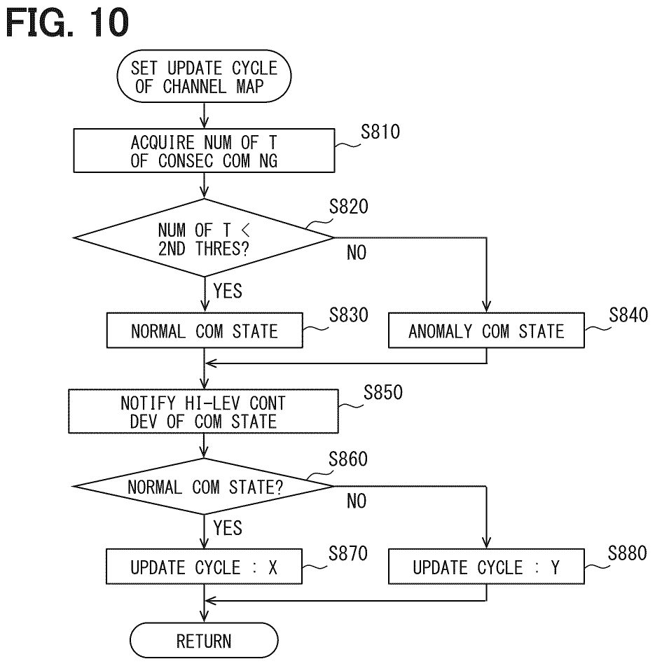

FIG. 10 is a flowchart showing an example of a channel map update cycle setting process executed in the master device 20 of the wireless communication system 10 according to this embodiment. In the first step S810, the master device 20 acquires the number of consecutive communication failures in the wireless communication with the slave device 30 for each communication event. In step S820, the master device 20 compares the acquired number of consecutive communication failures with a second threshold value. If the comparison shows that the number of consecutive communication failures is less than the second threshold value, the master device 20 proceeds to step S830 and determines that the communication state is in the normal state. On the other hand, if the number of consecutive communication failures is equal to or greater than the second threshold value, the master device 20 proceeds to step S840 and determines that the communication state is in the anomaly state.

In step S850, the master device 20 notifies the higher-level control device 1 of the communication state of the wireless communication between the master device 20 and the slave device 30 determined in step S830 or S840. This allows the higher-level control device 1 to know whether the communication state is in the normal state or in the anomaly state. The subsequent steps S860, S870, and S880 are the same as steps S550, S560, and S570 of the channel map update cycle setting process shown in FIG. 6, and therefore will not be described further.

### Third Embodiment

Next, a wireless communication system 10 according to a third embodiment of the present disclosure will be described with reference to the drawings. Since the wireless communication system 10 according to the present embodiment has similar configuration to the wireless communication system 10 of the first embodiment, description of the similar configuration will be omitted.

In the wireless communication system 10 according to the first embodiment described above, the master device 20 determines whether the communication state of the wireless communication between the master device 20 and the slave device 30 is in the normal state or in the anomaly state. On the other hand, in the wireless communication system 10 according to this embodiment, the higher-level control device 1, which uses information transmitted or received by the wireless communication between the master device 20 and the slave device 30, determines the state of the vehicle system based on the communication state of the wireless communication between the master device 20 and the slave device 30, and instructs the master device 20 on the update cycle of the channel map according to the determination result. That is, in this embodiment, the higher-level control device 1 is configured to give an external instruction to the master device 20 to change the update cycle of the channel map.

Hereinafter, the wireless communication system 10 according to the present disclosure will be described, focusing on the differences from the wireless communication system 10 according to the first embodiment. The wireless communication system 10 according to this embodiment differs from the wireless communication system 10 according to the first embodiment mainly in the channel map update cycle setting process.

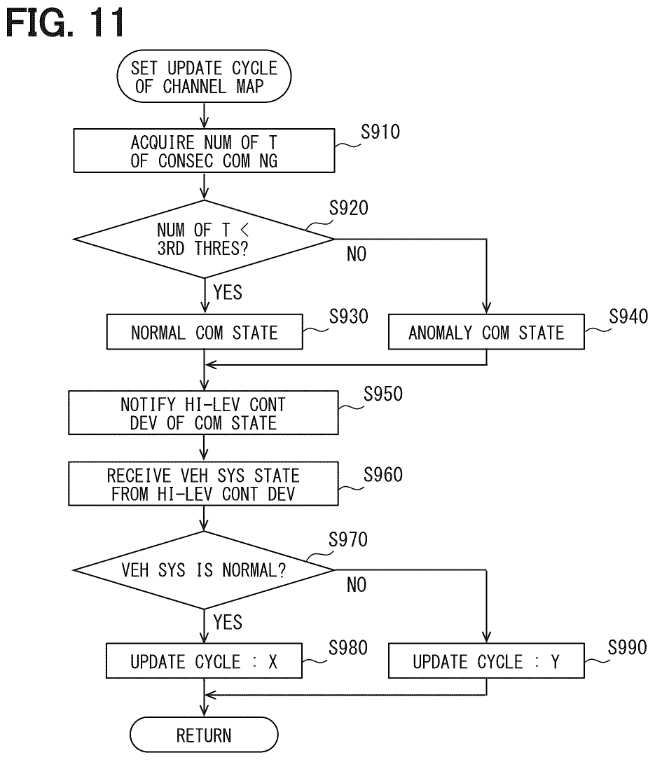

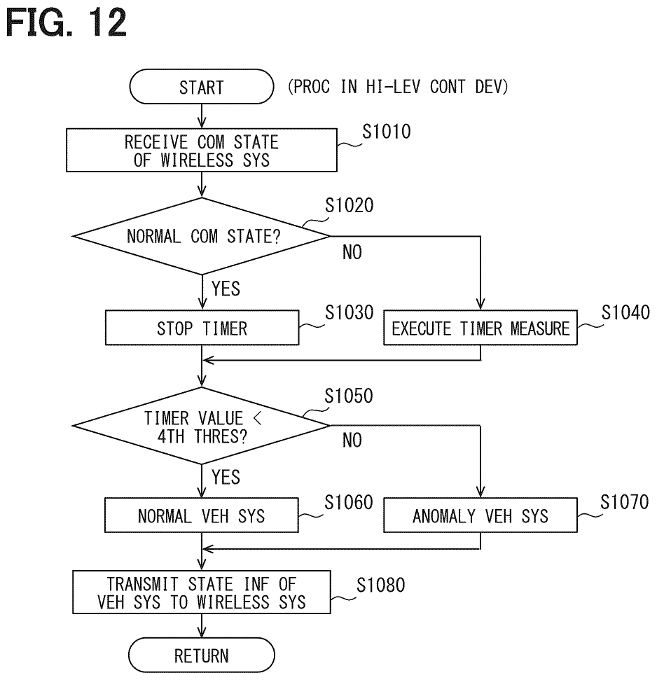

FIG. 11 is a flowchart showing an example of a channel map update cycle setting process executed in the master device 20 of the wireless communication system 10 according to this embodiment. FIG. 12 is a flowchart showing an example of process executed in the upper-level control device 1 to give an external instruction to the master device 20 to change the update cycle of the channel map.

In the first step S910 of FIG. 11, the master device 20 acquires the number of consecutive communication failures in the wireless communication with the slave device 30 for each communication event. In step S920, the master device 20 compares the acquired number of consecutive communication failures with a third threshold value (that is equal to or smaller than the second threshold value). If the comparison shows that the number of consecutive communication failures is less than the third threshold value, the master device 20 proceeds to step S930 and determines that the communication state is in the normal state. On the other hand, if the number of consecutive communication failures is equal to or greater than the third threshold value, the master device 20 proceeds to step S940 and determines that the communication state is in the anomaly state.

In step S950, the master device 20 notifies the higher-level control device 1 of the communication state of the wireless communication between the master device 20 and the slave device 30 determined in step S930 or S940. In step S960, the master device 20 receives the vehicle system state from the higher-level control device 1 as an external instruction to change the update cycle of the channel map. Then, in step S970, the master device 20 determines whether the vehicle system state is in the normal state or in the anomaly state based on the received vehicle system state. If it is determined that the vehicle system state is in the normal state, the master device 20 proceeds to step S980 and sets the channel map update cycle to X. If it is determined that the vehicle system state is in the anomaly state, the master device 20 proceeds to step S990 and sets the channel map update cycle to Y.

Next, the process shown in the flowchart of FIG. 12, which is executed by the higher-level control device 1, will be described. In the first step S1010, the higher-level control device 1 receives the communication state of the wireless communication in the wireless communication system 10 from the master device 20. More specifically, the result of the determination result in step S930 or S940 of the flowchart of FIG. 11 is received. In step S1020, the higher-level control device 1 determines the communication state of the wireless communication system 10 based on the received result of the determination. If it is determined that the communication state of the wireless communication system 10 is in the normal state, the higher-level control device 1 proceeds to step S1030, stops the timer measurement, and resets the timer value. On the other hand, if it is determined that the communication state of the wireless communication system 10 is in the anomaly state, the higher-level control device 1 proceeds to step S1040 and executes timer measurement by starting or continuing timer measurement. That is, the timer measures the time that has elapsed since the communication state of the wireless communication system 10 became in the anomaly state (i.e., in the communication interruption state).

In step S1050, the higher-level control device 1 compares the timer value with a fourth threshold value. In this comparison, if the timer value is less than the fourth threshold value, the higher-level control device 1 proceeds to step S1060 and determines that the vehicle system is in the normal state because the information transmitted or received between the master device 20 and the slave device 30 is available. On the other hand, if the timer value is equal to or greater than the fourth threshold value, the higher-level control device 1 proceeds to step S1070 and determines that the vehicle system is in the anomaly state because the information transmitted or received between the master device 20 and the slave device 30 is not available. In the above example, it has been explained that the higher-level control device 1 determines whether the vehicle system is in the normal state or in the anomaly state. However, since these determinations are based on the elapsed time since the wireless communication system became in the anomaly state (i.e., the communication interruption state), it can also be said that the higher-level control device 1 determines, on behalf of the master device 20, whether the communication state of the wireless communication system 10 is in the normal state or in the anomaly state.

In step S1080, the higher-level control device 1 transmits the state information of the vehicle system to the master device 20 of the wireless communication system 10 as an external instruction to change the update cycle of the channel map. The state information of the vehicle system to be transmitted is the vehicle system state determined in step S1060 or S1070.

The master device 20 sets the update cycle of the channel map in accordance with the received state information of the vehicle system. The setting of the channel map update cycle according to the state information of the vehicle system is executed by the processes of steps S970, S980, and S990 in the channel map update cycle setting process of FIG. 11 described above.

### Fourth Embodiment

Next, a wireless communication system 10 according to a fourth embodiment of the present disclosure will be described with reference to the drawings. Since the wireless communication system 10 according to the present embodiment has similar configuration to the wireless communication system 10 of the first embodiment, description of the similar configuration will be omitted.

In the wireless communication system 10 according to the third embodiment described above, the higher-level control device 1 gives an external instruction to the master device 20 of the wireless communication system 10 to change the update cycle of the channel map based on the communication state of the wireless communication between the master device 20 and the slave device 30. On the other hand, in the wireless communication system 10 according to this embodiment, when some anomaly (e.g., CPU anomaly, sensor anomaly, voltage anomaly and the like) occurs in the vehicle system (e.g., a battery management system) that is the control target by the higher-level control device 1, the higher-level control device 1 gives an external instruction to the master device 20 of the wireless communication system 10 to shorten the update cycle of the channel map. This reduces the possibility of an anomaly occurring in the wireless communication, and makes it possible to prevent an anomaly in the wireless communication from exacerbating the anomaly that has occurred in the vehicle system.

Hereinafter, the wireless communication system 10 according to the present disclosure will be described, focusing on the differences from the wireless communication system 10 according to the third embodiment. In this embodiment, similarly to the third embodiment, the higher-level control device 1 gives an external instruction to the master device 20 of the wireless communication system 10 to shorten the update cycle of the channel map. However, the condition under which the higher-level control device 1 gives an external instruction to the master device 20 to change the update cycle of the channel map is different from that in the third embodiment.

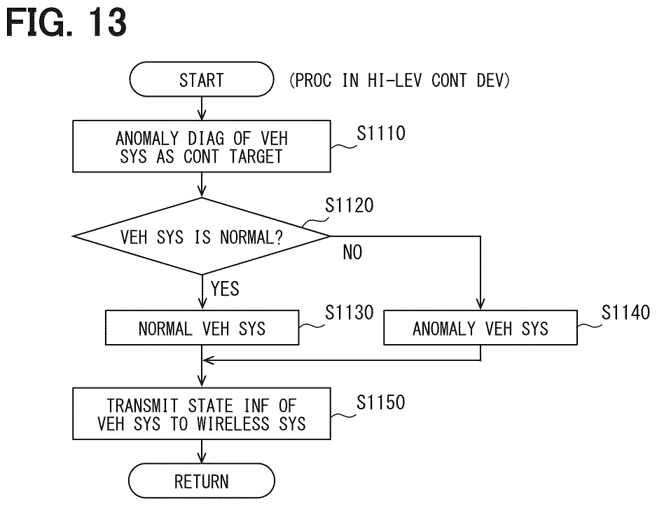

FIG. 13 is a flowchart showing an example of a process in which the higher-level control device 1 gives an external instruction to the master device 20 of the wireless communication system 10 to shorten the channel map update cycle when some anomaly occurs in the vehicle system as the control target. In the first step S1110, the higher-level control device 1 diagnoses whether or not any anomaly (such as a CPU anomaly, a sensor anomaly, or a voltage anomaly) has occurred in the vehicle system as the control target. This diagnosis may be executed by a diagnostic device that is capable of communicating with the higher-level control device 1 and that is provided separately from the higher-level control device 1.

In step S1120, the higher-level control device 1 determines whether the vehicle system is in a normal state or an anomaly state based on the diagnosis result acquired in step S1110. If it is determined that the vehicle system is in the normal state, the higher-level control device 1 proceeds to step S1130 and determines that the vehicle system is in the normal state. If it is determined that the vehicle system is in the anomaly state, the higher-level control device 1 proceeds to step S1140 and determines that the vehicle system is in the anomaly state. In step S1150, the higher-level control device 1 transmits the state information of the vehicle system to the master device 20 of the wireless communication system 10 as an external instruction to change the update cycle of the channel map. The state information of the vehicle system to be transmitted is the vehicle system state determined in step S1130 or S1140.

The master device 20 sets the update cycle of the channel map in accordance with the received state of the vehicle system. The setting of the channel map update cycle according to the state of the vehicle system is executed by the processes similar to steps S970, S980, and S990 in the channel map update cycle setting process of FIG. 11 described above.

### Fifth Embodiment

Next, a wireless communication system 10 according to a fifth embodiment of the present disclosure will be described with reference to the drawings. Since the wireless communication system 10 according to the present embodiment has similar configuration to the wireless communication system 10 of the first embodiment, description of the similar configuration will be omitted.

In the wireless communication system 10 according to the fourth embodiment described above, if any anomaly occurs in the vehicle system as the control target of the higher-level control device 1, the higher-level control device 1 gives an external instruction to the master device 20 of the wireless communication system 10 to shorten the update cycle of the channel map. On the other hand, in the wireless communication system 10 according to this embodiment, when a communication anomaly occurs in one of the other vehicle systems 2, 3, or 4, or when one of the other vehicle systems 2, 3, or 4 enters an operating state indicating an anomaly vehicle condition (for example, a state in which the possibility of a vehicle collision is increased), the higher-level control device 1 gives an external instruction to the master device 20 of the wireless communication system 10 to shorten the update cycle of the channel map.

For example, if the other vehicle systems are navigation systems or ETC systems that communicate with the outside, and a communication anomaly occurs in one of these vehicle systems, the vehicle is exposed to a noisy environment, and it is highly likely that a communication error may also occur in the wireless communication system 10. Therefore, when a communication anomaly occurs in another vehicle system, it may be preferable to reduce the possibility of a wireless communication anomaly occurring in the wireless communication system 10 by shortening the update cycle of the channel map. Also, for example, if the other vehicle systems are airbag systems that activate when a vehicle collision is about to occur, or collision mitigation systems that activate when the possibility of a collision arises, when these vehicle systems are activated, it is likely that the vehicle is in a critical situation where there is a high possibility of a collision. In such a situation, particularly when the control target of the higher-level control device 1 is a battery management system, it is important for the higher-level control device 1 to reliably acquire battery state information via the wireless communication system 10. For example, when a vehicle collision actually occurs, the higher-level control device 1 can determine whether the battery has been damaged or not from the battery state information. If there is a possibility that the battery is damaged, the higher-level control device 1 can take measures such as shutting off the relay. Therefore, when it is considered highly likely that other vehicle systems are operating and the vehicle is in a critical situation where a collision is likely, it may be preferable to reduce the possibility of a wireless communication anomaly occurring in the wireless communication system 10 by shortening the update cycle of the channel map.

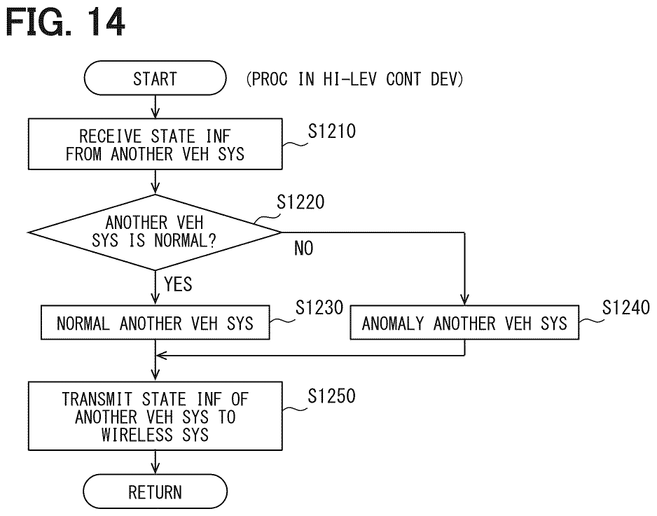

FIG. 14 is a flowchart showing an example of a process in which, when some anomaly occurs in the higher-level control device 1, such as a communication anomaly in the other vehicle systems 2, 3, and 4 or operation of the vehicle in a critical situation, the higher-level control device 1 receives an external instruction from the other vehicle systems 2, 3, and 4 to shorten the update cycle of the channel map, and gives the instruction to the master device 20 of the wireless communication system 10. In the first step S1210, the higher-level control device 1 receives the stats information from the other vehicle systems 2, 3, and 4 regarding the occurrence of communication anomaly and operation of the other vehicle systems.

In step S1220, the higher-level control device 1 determines, based on the state information of the other vehicle systems 2, 3, and 4 received in step S1210, whether or not an anomaly has occurred in the other vehicle systems 2, 3, and 4, which may have a high possibility that a communication anomaly has occurred in the other vehicle systems or that the vehicle is in a critical situation. If it is determined in this determination that the other vehicle systems 2, 3, and 4 are in the normal state, the higher-level control device 1 proceeds to step S1230 and determines that the other vehicle systems 2, 3, and 4 are in the normal state. On the other hand, if it is determined that the other vehicle systems 2, 3, and 4 are in the anomaly state, the higher-level control device 1 proceeds to step S1240 and determines that the other vehicle systems 2, 3, and 4 are in the anomaly state. In step S1250, the higher-level control device 1 transmits the state information of the other vehicle systems 2, 3, 4 to the master device 20 of the wireless communication system 10 as an external instruction to change the update cycle of the channel map. The state information of the other vehicle system 2, 3, 4 to be transmitted is the state of the other vehicle system 2, 3, 4 determined in step S1230 or S1240.

The master device 20 sets the update cycle of the channel map in accordance with the received state of the other vehicle system 2, 3, 4. The setting of the channel map update cycle according to the state of the other vehicle system 2, 3, 4 is executed by the processes similar to steps S970, S980, and S990 in the channel map update cycle setting process of FIG. 11 described above.

Although the preferred embodiments of the present disclosure have been described above, the present disclosure is not limited to the embodiments described above, and can be implemented with various modifications without departing from the gist of the present disclosure.

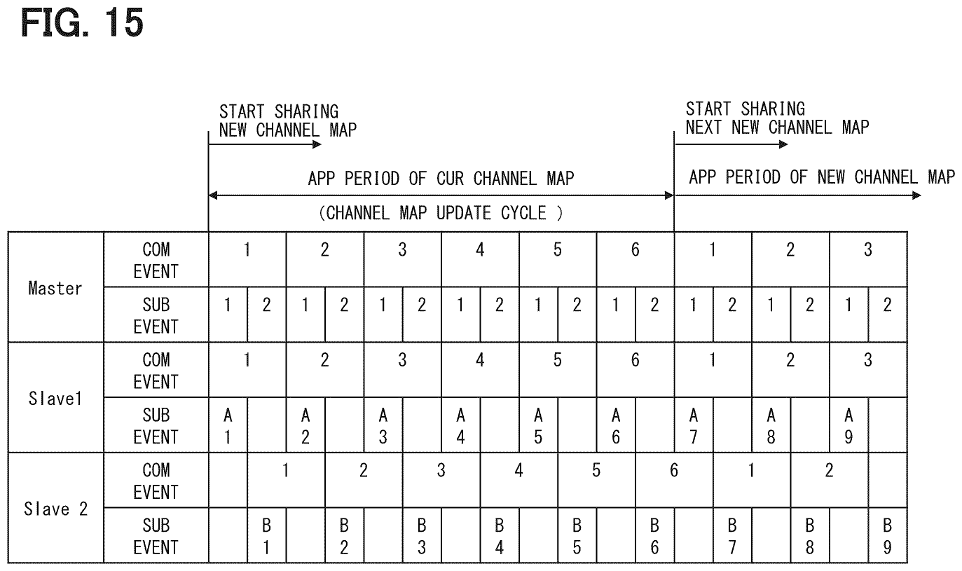

For example, in each of the above-described embodiments, an example has been described in which one master device 20 wirelessly communicates with one slave device 30. However, a plurality of slave devices 30 may be provided. When a plurality of slave devices 30 are provided, the master device 20 executes the activation sequence of FIG. 4 with each of the plurality of slave devices 30 individually, and establishes a wireless communication connection with each of the plurality of slave devices 30. In the communication sequence, the master device 20 can communicate with the multiple slave devices 30 in sequence by allocating a communication period (i.e., sub-event) to each of the multiple slave devices 30 in each communication event, as shown in the time chart of FIG. 15.

In the above-described embodiments, the channel map update cycle is changed in two stages depending on the communication state of the wireless communication between the master device 20 and the slave device 30 or an external instruction. However, the degree of communication state of the wireless communication between the master device 20 and the slave device 30 and the type of anomaly may be further subdivided, and the channel map update cycle may be changed to three or more stages based on an external instruction that corresponds to which type of state or anomaly.

The present disclosure discloses multiple technical ideas listed below and multiple combinations thereof. The following combination of technical features applies not only to the wireless communication system 10 but also to the wireless communication method and the wireless communication program.

### (Technical Feature 1)

In a wireless communication system, at least one master device (20) executes wireless communication with at least one slave device (30) via one communication channel sequentially selected from a plurality of communication channels.

The wireless communication system includes: a communication channel determination unit (S270, S280, S290) that determines a communication quality of each of the plurality of communication channels when the at least one master device communicates wirelessly with the at least one slave device, and determines the one communication channel to be used for the wireless communication based on a determination result of the communication quality of each of the plurality of communication channels; a channel map share unit (S310) that causes the master device to transmit a channel map indicating the one communication channel determined by the communication channel determination unit to the at least one slave device, and shares the channel map between the master device and the at least one slave device, the channel map shared between the at least one master device and the at least one slave device by the channel map share unit being periodically updated; and a cycle change unit (S300) that changes an update cycle of the channel map shared between the at least one master device and the at least one slave device by the channel map share unit in accordance with a communication state of the wireless communication between the at least one master device and the at least one slave device or an external instruction.

### (Technical Feature 2)

In the wireless communication system according to Technical feature 1, the cycle change unit changes the update cycle of the channel map depending on whether the communication state is a normal communication state where the communication state is good or an anomaly communication state where the communication state has deteriorated.

### (Technical Feature 3)

In the wireless communication system according to Technical feature 2, the cycle change unit sets the update cycle of the channel map in the anomaly communication state to be shorter than the update cycle of the channel map in the normal communication state.

### (Technical Feature 4)

In the wireless communication system according to Technical feature 2 or 3, the cycle change unit sets the update cycle of the channel map in the anomaly communication state to be shorter than the update cycle of the channel map in the normal communication state within a range that is equal to or greater than a predetermined minimum cycle.

### (Technical Feature 5)

In the wireless communication system according to any one of Technical features 2 to 4, the cycle change unit sets the update cycle of the channel map in the normal communication state to be longer than the update cycle of the channel map in the anomaly communication state within a range that is less than or equal to a predetermined maximum cycle.

### (Technical Feature 6)

The wireless communication system according to any one of Technical features 1 to 5 further includes: a transmission unit (S730) that transmits a reception confirmation signal for the channel map from the at least one slave device to the at least one master device in response to the slave device receiving the channel map; and a channel map switching unit (S640, S660, S670, S690, S700) that switches a current channel map used for the wireless communication of the at least one slave device with the channel map transmitted from the transmission unit in response to receiving a reception confirmation signal for the channel map transmitted from the transmission unit when the update cycle for the current channel map expires, and continues to use the current channel map without switching the current channel map with the channel map when not receiving the reception confirmation signal for the channel map transmitted from the transmission unit by an expiration of the update cycle of the current channel map.

### (Technical Feature 7)

In the wireless communication system according to any one of Technical features 1 to 6, the channel map share unit transmits the channel map to be used in a next update cycle from the master device to the slave device during the update cycle of a current channel map in which the current channel map is being used. The channel map share unit transmits the channel map a predetermined number of times according to a length of the update cycle of the current channel map in which the current channel map is being used.

### (Technical Feature 8)

The wireless communication system according to any one of Technical features 1 to 5, further includes: an identification unit (S520, S530, S540, S820, S830, S840) that specifies whether the communication state of the wireless communication between the master device and the slave device is a normal communication state in which the communication state is good or an anomaly communication state in which the communication state has deteriorated.

### (Technical Feature 9)

In the wireless communication system according to Technical feature 8, the identification unit specifies whether the communication state of the wireless communication between the master device and the slave device is the normal communication state or the anomaly communication state based on at least one of a communication error rate, which is a ratio of a numerical number of communication errors to a numerical number of communications executed, a numerical number of consecutive wireless communication failures, and a length of chronological time that the wireless communication is interrupted.

### (Technical Feature 10)

The wireless communication system according to Technical feature 1 further includes: a notification unit (S950) that notifies a first control unit (1), which uses information transmitted or received by the wireless communication between the master device and the slave device, of the communication state of the wireless communication between the master device and the slave device; and a determination unit (S1020, S1030, S1040, S1050, S1060, S1070) provided in the first control unit determines whether the communication state is a normal communication state in which the communication state is good or an anomaly communication state in which the communication state has deteriorated based on the communication state of the wireless communication between the master device and the slave device. The cycle change unit changes the update cycle of the channel map via the channel map share unit according to a determination result of the determination unit as an instruction from an outside.

### (Technical Feature 11)

In the wireless communication system according to Technical feature 10, the cycle change unit sets the update cycle of the channel map when the determination unit determines that the communication state is in the anomaly communication state to be shorter than the update cycle of the channel map when the determination unit determines that the communication state is in the normal communication state.

### (Technical Feature 12)

The wireless communication system according to Technical feature 1 further includes: a first control unit (1) that uses information transmitted or received by the wireless communication between the master device and the slave device and has a control target of a first system. The first control unit has a first anomaly determination unit (S1110) that determines whether an anomaly has occurred in the first system. The cycle change unit changes the update cycle of the channel map shared between the master device and the slave device via the channel map share unit in accordance with a determination result of the first anomaly determination unit, using the determination result of the first anomaly determination unit as an instruction from an outside.

### (Technical Feature 13)

In the wireless communication system according to Technical feature 12, the cycle change unit sets the update cycle of the channel map when the first anomaly determination unit determines that an anomaly has occurred in the first system to be shorter than the update cycle of the channel map when the first anomaly determination unit does not determine that the anomaly has occurred in the first system.

### (Technical Feature 14)

The wireless communication system according to Technical feature 1 further includes a vehicle system (2) having: a first control unit (1) that uses information transmitted or received by the wireless communication between the master device and the slave device and has a control target of a first system; and a second control unit that has a control target of a second system. The first control unit and the second control unit are configured to be able to communicate with each other. The second control unit has a second anomaly determination unit that determines whether an anomaly has occurred in the second system. The second control unit transmits to the first control unit an instruction from an outside to change the update cycle of the channel map based on a determination result of the second anomaly determination unit. The cycle change unit changes the update cycle of the channel map shared between the master device and the slave device via the channel map share unit in response to the instruction from the outside transmitted from the second control unit to the first control unit.

### (Technical Feature 15)

In the wireless communication system according to Technical feature 14, the cycle change unit sets the update cycle of the channel map when the second anomaly determination unit determines that an anomaly has occurred in the second system to be shorter than the update cycle of the channel map when the second anomaly determination unit does not determine that an anomaly has occurred in the second system.

### (Technical Feature 16)

In the wireless communication system according to Technical feature 14 or 15, the second control unit controls the second system using another wireless communication different from the wireless communication between the master device and the slave device. The second control unit transmits the instruction from the outside to the first control unit to shorten the update cycle of the channel map when a communication anomaly has occurred in the another wireless communication.

### (Technical Feature 17)

In the wireless communication system according to Technical feature 14 or 15, the first system and the second system are mounted on a vehicle. The second control unit has a function of determining a possibility of a collision of the vehicle. The second control unit transmits the instruction from the outside to the first control unit to shorten the update cycle of the channel map in response to determining that the possibility of collision of the vehicle has increased beyond a predetermined threshold. It is noted that a flowchart or the processing of the flowchart in the present application includes sections (also referred to as steps), each of which is represented, for instance, as S10. Further, each section can be divided into several sub-sections while several sections can be combined into a single section. Furthermore, each of thus configured sections can be also referred to as a device, module, or means.

While the present disclosure has been described with reference to embodiments thereof, it is to be understood that the disclosure is not limited to the embodiments and constructions. The present disclosure is intended to cover various modification and equivalent arrangements. In addition, while the various combinations and configurations, other combinations and configurations, including more, less or only a single element, are also within the spirit and scope of the present disclosure.

What is claimed is:

1. A wireless communication system in which at least one master device executes wireless communication with at least one slave device via one communication channel sequentially selected from a plurality of communication channels, the wireless communication system comprising:
at least one of (i) a circuit and (ii) a processor with a memory storing computer program code executable by the processor, the at least one of the circuit and the processor configured to cause the wireless communication system to execute:
determining a communication quality of each of the plurality of communication channels when the at least one master device communicates wirelessly with the at least one slave device, and determining the one communication channel to be used for the wireless communication based on a determination result of the communication quality of each of the plurality of communication channels;
causing the master device to transmit a channel map indicating the one communication channel in the determining of the one communication channel to the at least one slave device, and sharing the channel map between the master device and the at least one slave device, the channel map shared between the at least one master device and the at least one slave device in the sharing of the channel map being periodically updated; and
changing an update cycle of the channel map shared between the at least one master device and the at least one slave device in the sharing of the channel map in accordance with a communication state of the wireless communication between the at least one master device and the at least one slave device or an external instruction.

2. The wireless communication system according to claim 1, wherein:
the at least one of the circuit and the processor configured to cause the wireless communication system to execute:
determining the communication quality of each of the plurality of communication channels when the at least one master device communicates wirelessly with the at least one slave device, and determining the one communication channel to be used for the wireless communication based on the determination result of the communication quality of each of the plurality of communication channels as a communication channel determination unit;
causing the master device to transmit a channel map indicating the one communication channel in the determining of the one communication channel to the at least one slave device, and sharing the channel map between the master device and the at least one slave device, the channel map shared between the at least one master device and the at least one slave device in the sharing of the channel map being periodically updated as a channel map share unit; and
changing an update cycle of the channel map shared between the at least one master device and the at least one slave device in the sharing of the channel map in accordance with a communication state of the wireless communication between the at least one master device and the at least one slave device or an external instruction as a cycle change unit.

3. The wireless communication system according to claim 2, wherein:
the cycle change unit changes the update cycle of the channel map in accordance with whether the communication state is a normal communication state where the communication state is good or an anomaly communication state where the communication state has deteriorated.

4. The wireless communication system according to claim 3, wherein:
the cycle change unit sets the update cycle of the channel map in the anomaly communication state to be shorter than the update cycle of the channel map in the normal communication state.

5. The wireless communication system according to claim 3, wherein:
the cycle change unit sets the update cycle of the channel map in the anomaly communication state to be shorter than the update cycle of the channel map in the normal communication state within a range that is equal to or greater than a predetermined minimum cycle.

6. The wireless communication system according to claim 3, wherein:
the cycle change unit sets the update cycle of the channel map in the normal communication state to be longer than the update cycle of the channel map in the anomaly communication state within a range that is less than or equal to a predetermined maximum cycle.

7. The wireless communication system according to claim 2, wherein:
the at least one of the circuit and the processor is configured to cause the wireless communication system to further execute:
transmitting a reception confirmation signal for the channel map from the at least one slave device to the at least one master device in response to the slave device receiving the channel map as a transmission unit; and
switching a current channel map used for the wireless communication of the at least one slave device with the channel map transmitted from the transmission unit in response to receiving the reception confirmation signal for the channel map transmitted from the transmission unit when the update cycle for the current channel map expires, and continuing to use the current channel map without switching the current channel map with the channel map when not receiving the reception confirmation signal for the channel map transmitted from the transmission unit by an expiration of the update cycle of the current channel map as a channel map switching unit.

8. The wireless communication system according to claim 2, wherein:
the channel map share unit transmits the channel map to be used in a next update cycle from the master device to the slave device during the update cycle of a current channel map in which the current channel map is being used; and
the channel map share unit transmits the channel map a predetermined number of times according to a length of the update cycle of the current channel map in which the current channel map is being used.

9. The wireless communication system according to claim 2, wherein:
the at least one of the circuit and the processor is configured to cause the wireless communication system to further execute: specifying whether the communication state of the wireless communication between the master device and the slave device is a normal communication state in which the communication state is good or an anomaly communication state in which the communication state has deteriorated as an identification unit.

10. The wireless communication system according to claim 9, wherein:
the identification unit specifies whether the communication state of the wireless communication between the master device and the slave device is the normal communication state or the anomaly communication state based on at least one of a communication error rate, which is a ratio of a numerical number of communication errors to a numerical number of communications executed, a numerical number of consecutive wireless communication failures, and a length of chronological time that the wireless communication is interrupted.

11. The wireless communication system according to claim 2, wherein:
the at least one of the circuit and the processor is configured to cause the wireless communication system to further execute:
notifying a first control unit, which uses information transmitted or received by the wireless communication between the master device and the slave device, of the communication state of the wireless communication between the master device and the slave device; and
determining whether the communication state is a normal communication state in which the communication state is good or an anomaly communication state in which the communication state has deteriorated based on the communication state of the wireless communication between the master device and the slave device as a determination unit provided in the first control unit; and
the cycle change unit changes the update cycle of the channel map via the channel map share unit according to a determination result of the determination unit as an instruction from an outside.

12. The wireless communication system according to claim 11, wherein:
the cycle change unit sets the update cycle of the channel map when the determination unit determines that the communication state is in the anomaly communication state to be shorter than the update cycle of the channel map when the determination unit determines that the communication state is in the normal communication state.

13. The wireless communication system according to claim 2, wherein:
the at least one of the circuit and the processor is configured to cause the wireless communication system to further execute: using information transmitted or received by the wireless communication between the master device and the slave device as a first control unit having a control target of a first system;
the first control unit has a first anomaly determination unit that determines whether an anomaly has occurred in the first system; and
the cycle change unit changes the update cycle of the channel map shared between the master device and the slave device via the channel map share unit in accordance with a determination result of the first anomaly determination unit, using the determination result of the first anomaly determination unit as an instruction from an outside.

14. The wireless communication system according to claim 13, wherein:
the cycle change unit sets the update cycle of the channel map when the first anomaly determination unit determines that an anomaly has occurred in the first system to be shorter than the update cycle of the channel map when the first anomaly determination unit does not determine that the anomaly has occurred in the first system.

15. The wireless communication system according to claim 2, further comprising:
a vehicle system having: a first control unit that uses information transmitted or received by the wireless communication between the master device and the slave device and has a control target of a first system; and a second control unit that has a control target of a second system, wherein:
the first control unit and the second control unit are configured to be able to communicate with each other;
the second control unit has a second anomaly determination unit that determines whether an anomaly has occurred in the second system;
the second control unit transmits to the first control unit an instruction from an outside to change the update cycle of the channel map based on a determination result of the second anomaly determination unit; and
the cycle change unit changes the update cycle of the channel map shared between the master device and the slave device via the channel map share unit in response to the instruction from the outside transmitted from the second control unit to the first control unit.

16. The wireless communication system according to claim 15, wherein:
the cycle change unit sets the update cycle of the channel map when the second anomaly determination unit determines that an anomaly has occurred in the second system to be shorter than the update cycle of the channel map when the second anomaly determination unit does not determine that an anomaly has occurred in the second system.

17. The wireless communication system according to claim 15, wherein:
the second control unit controls the second system using another wireless communication different from the wireless communication between the master device and the slave device; and
the second control unit transmits the instruction from the outside to the first control unit to shorten the update cycle of the channel map when a communication anomaly has occurred in the another wireless communication.

18. The wireless communication system according to claim 15, wherein:
the first system and the second system are mounted on a vehicle;
the second control unit has a function of determining a possibility of a collision of the vehicle; and
the second control unit transmits the instruction from the outside to the first control unit to shorten the update cycle of the channel map in response to determining that the possibility of collision of the vehicle has increased beyond a predetermined threshold.

19. A wireless communication method for which at least one master device executes wireless communication with at least one slave device via one communication channel sequentially selected from a plurality of communication channels, the wireless communication method comprising:
determining a communication quality of each of the plurality of communication channels when the at least one master device communicates wirelessly with the at least one slave device, and determining the one communication channel to be used for the wireless communication based on a determination result of the communication quality of each of the plurality of communication channels;
causing the master device to transmit a channel map indicating the one communication channel in the determining of the one communication channel to the at least one slave device, and sharing the channel map between the master device and the at least one slave device, the channel map shared between the at least one master device and the at least one slave device being periodically updated; and
changing an update cycle of the channel map shared between the at least one master device and the at least one slave device in accordance with a communication state of the wireless communication between the at least one master device and the at least one slave device or an external instruction.

20. A non-transitory computer readable storage medium comprising instructions being executed by a computer, the instructions including a computer-implemented wireless communication method for which at least one master device executes wireless communication with at least one slave device via one communication channel sequentially selected from a plurality of communication channels, the instructions including:
determining a communication quality of each of the plurality of communication channels when the at least one master device communicates wirelessly with the at least one slave device, and determining the one communication channel to be used for the wireless communication based on a determination result of the communication quality of each of the plurality of communication channels;
causing the master device to transmit a channel map indicating the one communication channel in the determining of the one communication channel to the at least one slave device, and sharing the channel map between the master device and the at least one slave device, the channel map shared between the at least one master device and the at least one slave device being periodically updated; and
changing an update cycle of the channel map shared between the at least one master device and the at least one slave device in accordance with a communication state of the wireless communication between the at least one master device and the at least one slave device or an external instruction.
